(19) United States
(12) Patent Application Publication
(10) Pub. No.: US 2009/0184219 A1
(43) Pub. Date: Jul. 23, 2009

(54) DISPLAY HOOK ASSEMBLY WITH FLEXIBLE HOOK

(76) Inventor: Ying-Ju Chen, Taichung City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/015,794

(22) Filed: Jan. 17, 2008

(51) Int. Cl. A47F 7/00; F16B 47/00

(52) U.S. Cl. 248/205.5; 248/339

(57) ABSTRACT

A display hook assembly includes a flat body which includes an extension extending therefrom and the extension shares a common plane with the flat body. The extension includes a metal plate received therein so that the extension can be bent to form a hook. A positioning member such as a suction disk is connected to the flat body so as to connect the display hook assembly on a wall.

### FIELD OF THE INVENTION

The present invention relates to a display hook assembly with an extension made by flexible material and can be bent to be the hook.

### BACKGROUND OF THE INVENTION

A conventional display hook generally includes a board which has a first surface fixed on the wall and a second surface of the board has a hook which extends a distance from the second surface. The hook is made by hard material such as metal or plastic and is integrally formed with the board. The hook occupies a certain space when viewed from either side of the display hook assembly so that the display hook assemblies cannot be overlapped because of the hooks which occupy a lot of space and is disadvantageous for transportation. Besides, when putting the hook assemblies in a bag, the hooks require a certain space so that the number of the hook assembly is limited and wastes a lot of space.

The present invention intends to provide a display hook assembly which has an extension located to share a common plane of the body so that the display hook assemblies can be overlapped to save transportation space. The extension can be bent to be a hook when in use.

### SUMMARY OF THE INVENTION

The present invention relates to a display hook assembly that includes a flat body and an extension extends from the body and shares a common plane with the body. The extension includes a metal plate received therein so that the extension can be bent to form a hook.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the display hook assembly of the present invention;

FIG. 2 is a partial cross sectional view to show the display hook assembly of the present invention;

FIG. 3 shows the extension is bent to be a hook, and

FIG. 4 shows the display hook assemblies of the present invention are overlapped with each other.

### DETAILED DESCRIPTION OF THE PREFERRED EMBODIMENT

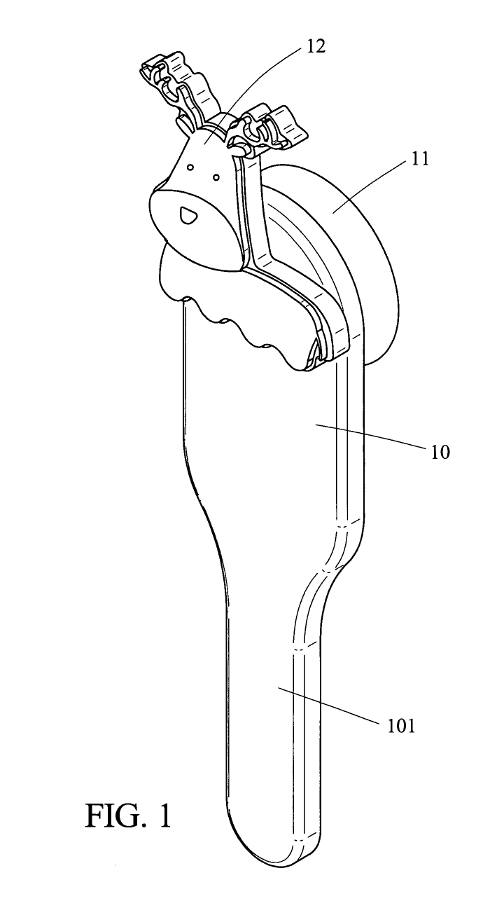

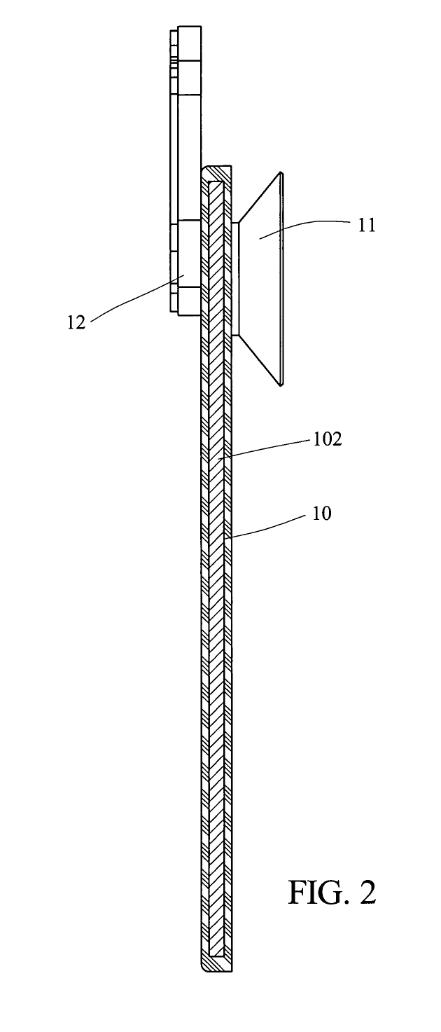

Referring to FIGS. 1 and 2, the display hook assembly of the present invention comprises a flat body 10 having an extension 101 extending therefrom and the extension 101 shares a common plane with the flat body 10. A metal plate 101 is received in both of the flat body 10 and the extension 101. The flat body 10 and the extension 101 include rubber which encloses the metal plate 101 so that the flat body 10 and the extension 101 can be made to include smooth surface which does not damage objects.

A positioning member 11 such as a suction disk is connected to a surface of the flat body 10 and a decoration piece 12 is connected to the other surface of the flat body 10. The decoration piece 12 can be any desired shape or pattern.

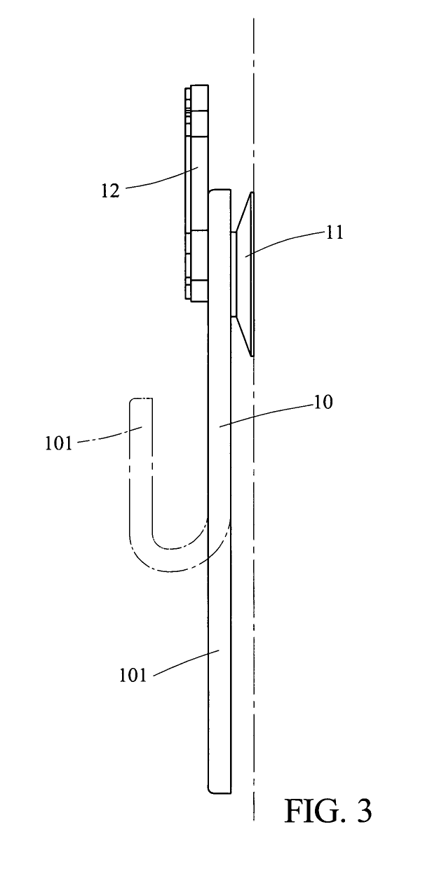

As shown in FIG. 3, when in use, the extension 101 can be easily bent to be a hook and because the rubber surface, the hook does not scratch or damage the object to be hanged on the hook.

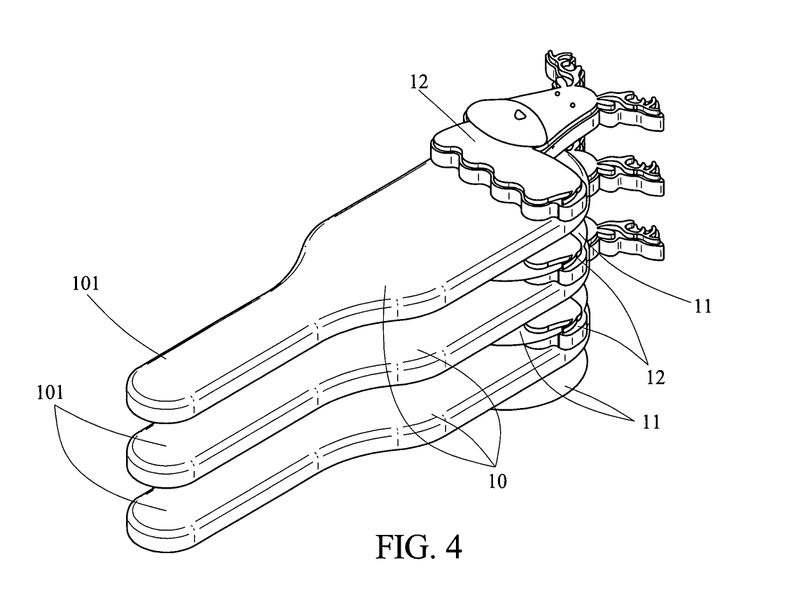

As shown in FIG. 4, the display hook assemblies can be easily overlapped to each other because of the extension 101 is located at the same plane with the flat body 10 when being transported, the positioning member 11 and the decoration member 12 occupy small space so that the overlapped display hook assemblies occupy limited space. The positioning member 11 and the decoration member 12 can also be individual parts from the body 10 so as to further save space when being transported.

While we have shown and described the embodiment in accordance with the present invention, it should be clear to those skilled in the art that further embodiments may be made without departing from the scope of the present invention.

What is claimed is:

1. A display hook assembly comprising:
a flat body having an extension extending therefrom which shares a common plane with the flat body, the extension being bent to form a hook, and
a positioning member connected to a surface of the flat body and the positioning member being a suction disk.

2. The assembly as claimed in claim 1, wherein the extension includes a metal plate received therein.

3. The assembly as claimed in claim 1, wherein a decoration piece is connected to the flat body.

4. The assembly as claimed in claim 1, wherein a metal plate is received in the flat body and the extension includes.
